(19) United States
(12) Patent Application Publication
(10) Pub. No.: US 2014/0251254 A1
(43) Pub. Date: Sep. 11, 2014

(54) OIL SCRAPER RING FOR A PISTON OF AN INTERNAL COMBUSTION ENGINE

(71) Applicant: Holger Franz, Baltmannsweiler (DE)

(72) Inventor: Holger Franz, Baltmannsweiler (DE)

(73) Assignee: MAHLE International GmbH, Stuttgart (DE)

(21) Appl. No.: 14/130,547

(22) PCT Filed: Jul. 4, 2012
(86) PCT No.: PCT/DE2012/000672

§ 371 Date: Apr. 8, 2014

(30) Foreign Application Priority Data
Jul. 5, 2011 (DE) 10 2011 106 656.3

(51) Int. Cl. F02F 11/00

(52) U.S. Cl. CPC F02F 11/002
USPC 123/193.6

(57) ABSTRACT

The invention relates to an oil scraper ring (1) for a piston (13) of an internal combustion engine, comprising several lamellae (2, 3), each having a joint (19, 19′), and a meander-shaped spacer spring (4) having a joint (17). In order to prevent the ends of the spacer spring (4) and the lamella (2) from interlocking, the joint (19) of the lamella (2) encloses an acute angle with the radius of the lamella (2).

The invention relates to an oil control ring for a piston of an internal combustion engine, consisting of at least one lamella having an abutting edge, in each instance, and of a meander-shaped spacer spring having an abutting edge, whereby the lamella and the spacer spring stand in contact with one another.

An oil control ring of the type stated initially is known from the patent application FR 2 889 562. It is a disadvantage, in this connection, that the lamella of the known oil control ring has an abutting edge that lies parallel to the radius of the lamella, so that the ends of the lamella and of the spacer spring can hook into one another during the relative movement between the lamella and the spacer spring that is unavoidable during engine operation. This leads to damage of the lamella, thereby causing its oil control effect to be impaired, which brings with it the risk of damage to the engine.

It is therefore the task of the present invention to avoid this disadvantage of the state of the art, in other words to configure the oil control ring in such a manner that the ends of the lamella and of the spacer spring are prevented from hooking into one another.

This task is accomplished in that the abutting edge of the at least one lamella encloses an acute angle with the radius of the at least one lamella. This brings about the result that the ends of the lamella abutting edge do not come into contact with the ends of the spring abutting edge over their entire width, so that in this connection, the lamella abutting edges slide over the spring abutting edges, and hooking of the spring abutting edges into the lamella abutting edges is prevented.

Advantageous further developments are evident from the dependent claims.

An exemplary embodiment of the invention will be described below, using the drawings. These show:

FIG. 1 a three-part oil control ring, in section, having two lamellas and a spacer spring,

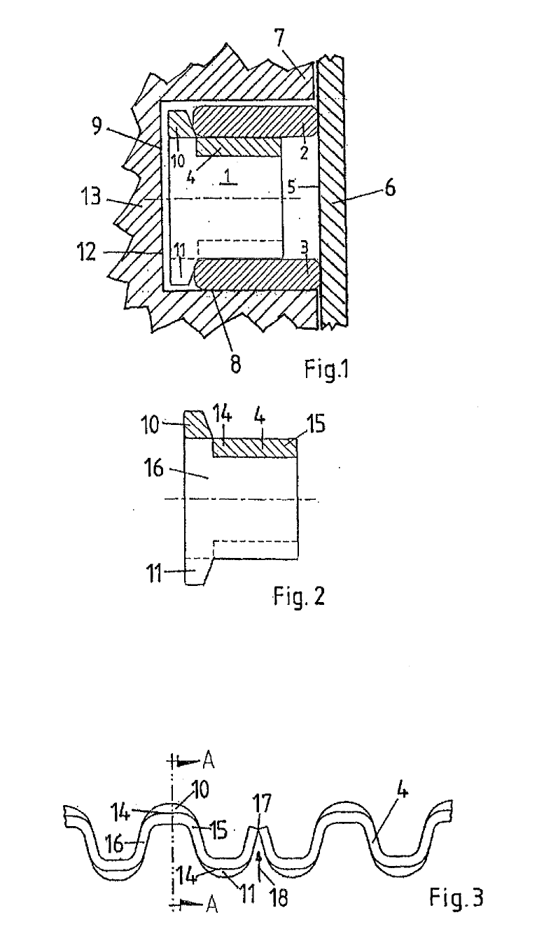

FIG. 2 a section through the spacer spring along the line AA in FIG. 3,

FIG. 3 a side view of the spacer spring,

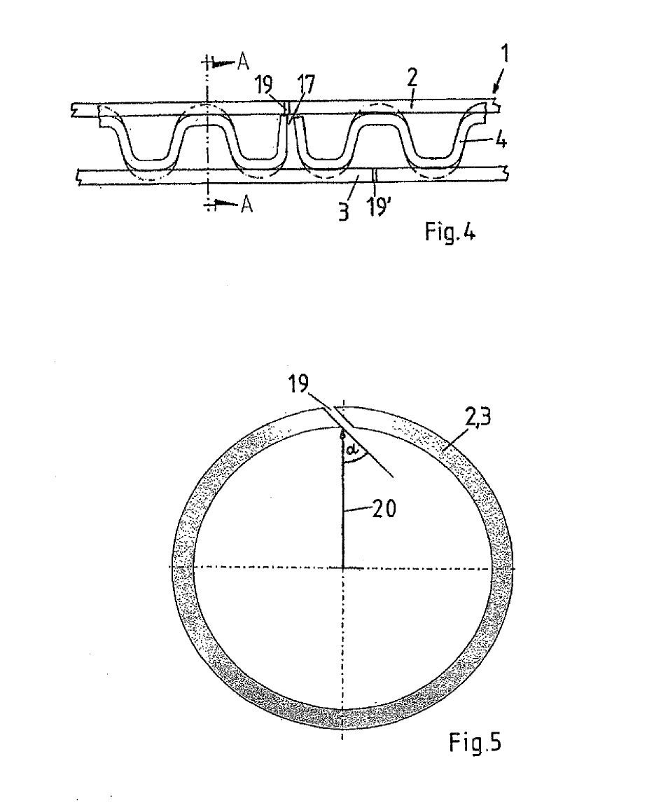

FIG. 4 a side view of the oil control ring under a load, and

FIG. 5 a top view of a lamella.

FIG. 1 shows an oil control ring 1 that consists of two lamellas 2 and 3 and a spacer spring 4, and is mounted in a ring groove 9 of a piston 13 for an internal combustion engine, which groove consists of two flanks 7, 8 and a bottom surface 12.

The task of the oil control ring 1 consists in stripping off excess oil adhering to the working surface 5 of a cylinder liner 6, part of which is shown in FIG. 1. On the side facing away from the cylinder liner 6, the spacer spring 4 has support elements 10 and 11 for this purpose, with which elements the lamellas 2, 3 make contact, and by way of which elements the spacer spring 4 presses the lamellas 2, 3 onto the working surface 5 of the cylinder liner 6.

FIGS. 2 and 3 show the spacer spring 4, whereby in FIG. 2, a section through the spacer spring 4 along the line AA is shown in FIG. 3. This makes it clear that the spacer spring 4 is configured in meander shape, and that the support elements 10 and 11 disposed on the apexes 14 of the meander arches 15 are continuations of the shanks 16 of the meander arches 15 and lie only loosely against the apexes 14 of the meander arches 15. Here, it is actually possible to leave a gap between the support elements 10 and 11 and the apexes 14 of the meander arches 15.

FIG. 3 shows that the spacer spring 4 has an abutting edge 17 that can move in the direction of the arrow 18 during engine operation, as a function of the load. Such a situation is shown in FIG. 4, which shows a side view of the oil control ring 1 having the spacer spring 4 and the lamellas 2, 3 having the abutting edges 19, 19′. In this connection, it occurs again and again, during engine operation, that the lamella 2 is displaced with regard to the spacer spring 4, to such an extent that the abutting edge 17 of the spacer spring 4 and the abutting edge 19 of the lamella 2 come to lie opposite one another, and that contact between the abutting edge 17 of the spacer spring 4 and the abutting edge 19 of the lamella 2 occurs due to a deformation of the ring groove 9 under the load of the combustion gases and the mass forces acting on the piston 13. In this connection, it can occur that the ends of the spacer spring 4 and the ends of the lamella 2 hook into one another during the relative movement between the lamellas 2, 3 and the spacer spring 4 that occurs during engine operation, and this leads to damage of the lamella 2 in the region of its abutting edge 19, caused by the ends of the spacer spring 4. As a result, the oil stripping effect of the lamella 2 of the oil control ring 1 is worsened, and this can then also lead to damage to the engine.

This problem is solved, according to the invention, in that the lamellas 2, 3 of the oil control ring 1 have an abutting edge 19 that lies at a slant relative to the radius 20 of the lamella 2, 3, which edge encloses an acute angle α with the radius 20 of the lamella 2, 3, as shown in FIG. 5. This has the effect that the ends of the lamella abutting edge 19 do not come into contact with the ends of the spring abutting edge 17 over their entire width, so that in this connection, the lamella abutting edge ends slide over the spring abutting edge ends, and hooking of the spring abutting edge ends into the lamella abutting edge ends is prevented.

In this connection, the abutting edges 19, 19′ of the lamellas 2, 3 can enclose different angles a with the radius 20 of the lamella 2, 3, in each instance, i.e. they can intersect at a specific angle, thereby increasing the stability of the oil control ring 1 when the abutting edges 19, 19′ of the lamellas 2, 3 come to lie opposite one another.

In many cases, oil return grooves that lie radially are introduced into the flank 8 of the ring groove 9 that faces away from the piston crown, so that when the lower lamella 3 makes a rotational movement, its abutting edge 19′ hooks into the flanks of the oil return groove. Because of the slanted position of the abutting edge 19′, which encloses an acute angle u with the radius 20 of the lamella 3, this hooking is prevented.

### REFERENCE SYMBOL LIST

α angle between the abutting edge of a lamella and the radius of the lamella
1 oil control ring
2, 3 lamella
4 spacer spring
5 working surface of the cylinder liner 6
6 cylinder liner
7, 8 flanks of the ring groove 9
9 ring groove
10, 11 support element
12 bottom surface of the ring groove 9
13 piston
14 apex of the meander arch 15
15 meander arch
16 shank of the meander arch 15
17 abutting edge of the spacer spring 4
18 arrow
19, 19′ abutting edge of the lamella 2, 3
20 radius of the lamella 2, 3

1. Oil control ring (1) for a piston (13) of an internal combustion engine, consisting of at least one lamella (2, 3) having an abutting edge (19, 19′), in each instance, and of a meander-shaped spacer spring (4) having an abutting edge (17), wherein the at least one lamella (2, 3) and the spacer spring (4) stand in contact with one another, wherein the abutting edge (19, 19′) of the at least one lamella (2, 3) encloses an acute angle (α) with the radius (20) of the at least one lamella (2, 3).

2. Oil control ring (1) for a piston (13) according to claim 1, comprising two lamellas (2, 3) that lie parallel to one another, between which the spacer spring (4) is disposed, wherein each lamella (2, 3) has an abutting edge (19, 19′).

3. Oil control ring (1) for a piston according to claim 2, wherein the abutting edges (19, 19′) of the lamellas (2, 3) enclose different angles with the radius (20) of the lamella (2, 3), in each instance.
